(19) United States
(12) Patent Application Publication
(10) Pub. No.: US 2008/0136348 A1
(43) Pub. Date: Jun. 12, 2008

(54) LIGHT-EMITTING DISPLAY ARCHITECTURE

(75) Inventors: Christopher Varrin, Monte Sereno, CA (US); Nils Thorjussen, Palo Alto, CA (US); Matthew Ward, San Francisco, CA (US); Jeremy Hochman, Austin, TX (US); David Main, Boulder Creek, CA (US)

Correspondence Address: OSHA LIANG L.L.P., 1221 MCKINNEY STREET, SUITE 2800, HOUSTON, TX, 77010, US

(73) Assignee: ELEMENT LABS, INC., Santa Clara, CA (US)

(21) Appl. No.: 11/759,859

(22) Filed: Jun. 7, 2007

Related U.S. Application Data
(60) Provisional application No. 60/812,660, filed on Jun. 9, 2006.
(60) Provisional application No. 60/848,988, filed on Oct. 3, 2006.
(60) Provisional application No. 60/892,378, filed on Mar. 1, 2007.
(60) Provisional application No. 60/896,788, filed on Mar. 23, 2007.

(51) Int. Cl. H05B 37/02

(52) U.S. Cl. 315/291

(57) ABSTRACT

A light-emitting display driver architecture and a method of supplying power and data thereto are disclosed. The driver architecture includes a wire interface with a host controller electrically connected thereto. Further, first and second pixel nodes are connected to the wire interface in parallel. The first and second pixel nodes each include a communication unit, a control unit, a driver, and a light-emitting element. A data signal and a power signal is then transmitted from the host controller through the wire interface, in which data is extracted from the data signal for the first pixel node based upon a fixed unique ID corresponding to the first pixel node.

### CROSS-REFERENCE TO RELATED APPLICATIONS

This application claims benefit, under 35 U.S.C. § 119, of U.S. Provisional Application Ser. No. 60/812,660, filed on Jun. 9, 2006 and entitled “Driver Architecture for Light Emitting Displays” in the name of Jeremy Hochman, David Main, Nils Thorjussen, Christopher Varrin, and Matthew Ward. This application also claims benefit of U.S. Provisional Application Ser. No. 60/848,988, filed on Oct. 3, 2006 and entitled “Multi-Drop Distributed Node Micro-Controller Architecture” in the name of David Main. This application also claims benefit of U.S. Provisional Application Ser. No. 60/892,378, filed on Mar. 1, 2007 and entitled “Robust Addressing System for Large, Pixel Based, Displays” in the name of Matthew Ward. This application also claims benefit of U.S. Provisional Application Ser. No. 60/896,788, filed on Mar. 23, 2007 and entitled “Display with Interactive Pixels” in the name of David Main and Christopher Varrin. The disclosures of these U.S. Provisional Applications are incorporated herein by reference in their entirety.

### BACKGROUND OF DISCLOSURE

1. Field of the Disclosure

Embodiments disclosed herein generally relate to a light-emitting display architecture. More specifically, embodiments disclosed herein relate to an improved light-emitting display architecture with pixel nodes for use in various industries.

2. Background Art

Display units for entertainment, architectural, and advertising purposes have commonly been constructed from numbers of light-emitting elements, such as light-emitting diodes (“LEDs”) or incandescent lamps mounted onto flat panels. These light-emitting elements may be selectively turned on-and-off to create patterns, graphics, and video displays for both informational and aesthetic purposes. It is well known to construct these displays of tiles or large panels, each containing several light-emitting elements, which may be assembled in position for an entertainment show or event, or as an architectural or advertising display. Examples of such systems are disclosed in U.S. Pat. Nos. 6,813,853, 6,704,989, 6,677,918, and 6,314,669.

Large video displays used in advertising, sports, and other public video applications are built using a combination of plastic housing and structural components. These video displays generally house a circuit board containing light-emitting diodes, power distribution, and driver electronics. The assemblies are well known and may be supplied as single pixels, as described by Yoksza et al in U.S. Pat. No. 5,410,328, multiple pixel strips, as disclosed by Masanobu Miura in U.S. Pat. No. 5,268,828, and multi pixel modules, as described by Matsumura et al in U.S. Pat. No. 5,785,415. Modifications and refinements of these basic designs are well known and may include the substitution of surface mount emitters for through-hole emitters.

Recently, lighting technology has been applied to create large displays with similar functionality to earlier single pixel displays created by traditional video companies. These low-resolution displays are sometimes used with higher resolution screens and are controlled by the same media servers of the higher resolution screens. As such, many of these systems use communication schemes based on a standard lighting protocol, such as the standard lighting protocol DMX 512, or on a proprietary system such as those disclosed within U.S. Pat. Nos. 6,016,038 and 6,166,496. Addressing in the DMX 512 protocol is normally limited because this protocol requires addressing at each individual fixture. Thus, proprietary protocols along with dip switches or remote boxes have been used for larger installations in order to set addresses. This arrangement may not be ideal for very large installations with large numbers of pixel nodes.

Additionally, the systems used for these large displays are commonly more distributed with components decentralized in order to increase flexibility. For instance, in FIG. 2, a system may use individual pixels 203 with all drivers 201 remote or externally connected to the pixels 203. This configuration may therefore allow the pixels 203 to be of minimum size because the necessary power and data components 201 and 206 are disposed outside and away from the pixels. However, these systems may be very cable intensive and create multiple dependencies among elements.

Further, low-density video display systems are often made overly complicated by the requirement to either physically address each individual pixel or to physically address pixels in large groups using a central distribution box. A system where each pixel is individually addressed is more adaptable and elegant because the cabling system may be more flexible. Further, a system with a central distribution box is more easily maintained because an employee may change a faulty pixel without having to understand or learn the addressing system.

All video display systems require large numbers of light-emitting elements or pixels acting independently and, thus, have a requirement for the distribution of large amounts of continually changing data. Prior art systems have most commonly used systems based on a shift register design with input driven either directly by computer derived data or video signals. Such large systems are typically not robust or fault tolerant and are subject to interference and failure. In a standard shift register based driver system, the failure of a single driver may cause the loss or failure of an entire string of pixels. FIG. 1 is an example of prior art system that uses standard lighting protocols and cable configurations. Specifically, in this system, the nodes are connected to the host controller in series or daisy chain connection arrangement. A failure in any single node 103 will result in the loss of all nodes 103 connected downstream of the failed node 103 and host controller 105. In addition, a large shift register driven system can generate undesirable electromagnetic compatibility (EMC) noise.

As displays are increasingly used in architectural installations where access for maintenance may be difficult and expensive (or even virtually impossible in the case of a system embedded in a glass window), the need for extreme reliability increases. Accordingly, there exists a need for a light-emitting display driver architecture that improves upon these prior art displays for continued development and success within the various light-emitting industries.

### SUMMARY OF INVENTION

In one aspect, embodiments disclosed herein relate to a light-emitting display driver architecture. The driver architecture includes a wire interface, a host controller electrically connected to the wire interface, and a first pixel node and a second pixel node connected to the wire interface in parallel. The first pixel node and the second pixel node each include a communication unit electrically connected to the wire interface, a control unit electrically connected to the communication unit, a driver electrically connected to the control unit, and a light-emitting element electrically connected to the driver.

In another aspect, embodiments disclosed herein relate to a method of supplying power and data to a light-emitting display driver architecture. The method includes transmitting a power signal and a data signal from a host controller through a wire interface to a first pixel node and a second pixel node connected in parallel across the wire interface, and extracting data from the data signal with the first pixel node based upon a fixed unique ID corresponding to the first pixel node. The method further includes controlling a driver and a light-emitting element of the first pixel node based upon the extracted data.

In yet another aspect, embodiments disclosed herein relate to another light-emitting display driver architecture. The driver architecture includes a first pixel node and a second pixel node each having a light-emitting element, and a frame having a first pixel location and a second pixel location. The first pixel location and the second pixel location each have a fixed unique ID. The first pixel node is disposed at the first pixel location, thereby acquiring the fixed unique ID of the first pixel location, and the second pixel node is disposed at the second pixel location, thereby acquiring the fixed unique ID of the second pixel location.

Other aspects and advantages of the invention will be apparent from the following description and the appended claims.

### BRIEF DESCRIPTION OF DRAWINGS

FIG. 1 shows a view of a prior art display apparatus.

FIG. 2 shows a view of a prior art display apparatus.

FIG. 3 shows a light-emitting display driver architecture in accordance with embodiments disclosed herein.

FIGS. 4A-D show block diagrams of a pixel node in accordance with embodiments disclosed herein.

FIG. 5 shows a block diagram of a light-emitting display driver architecture in accordance with embodiments disclosed herein.

FIG. 6A and FIG. 6B show block diagrams of a pixel node in accordance with embodiments disclosed herein.

FIG. 7 shows a physical feature that defines a fixed unique ID in accordance with embodiments disclosed herein.

FIG. 8 shows another physical feature that defines a fixed unique ID in accordance with embodiments disclosed herein.

FIG. 9 shows another physical feature that defines a fixed unique ID in accordance with embodiments disclosed herein.

FIG. 10 shows another physical feature that defines a fixed unique ID in accordance with embodiments disclosed herein.

FIGS. 11A-D show wire interface arrangements in accordance with embodiments disclosed herein.

FIG. 12 shows a pixel node with additional functional units in accordance with embodiments disclosed herein.

FIGS. 13A-E show a pixel node with an electrically connected sensor unit in accordance with embodiments disclosed herein.

FIGS. 14A and 14B show a pixel node with an electrically connected separator unit in accordance with embodiments disclosed herein.

FIG. 14C shows a pixel node with an electrically connected separator in accordance with embodiments disclosed herein.

FIG. 15 shows a pixel node arrangement in accordance with embodiments disclosed herein.

FIG. 16 shows a pixel node arrangement in accordance with embodiments disclosed herein.

FIG. 17 shows a pixel node arrangement in accordance with embodiments disclosed herein.

FIGS. 18A-D show a simplified schematic of functional units incorporating redundant elements in accordance with embodiments disclosed herein.

FIG. 19 shows a simplified schematic of a light-emitting element incorporating redundant elements in accordance with embodiments disclosed herein.

FIG. 20 shows relative amplitudes for a given frequency for a spread spectrum clock in accordance with embodiments disclosed herein.

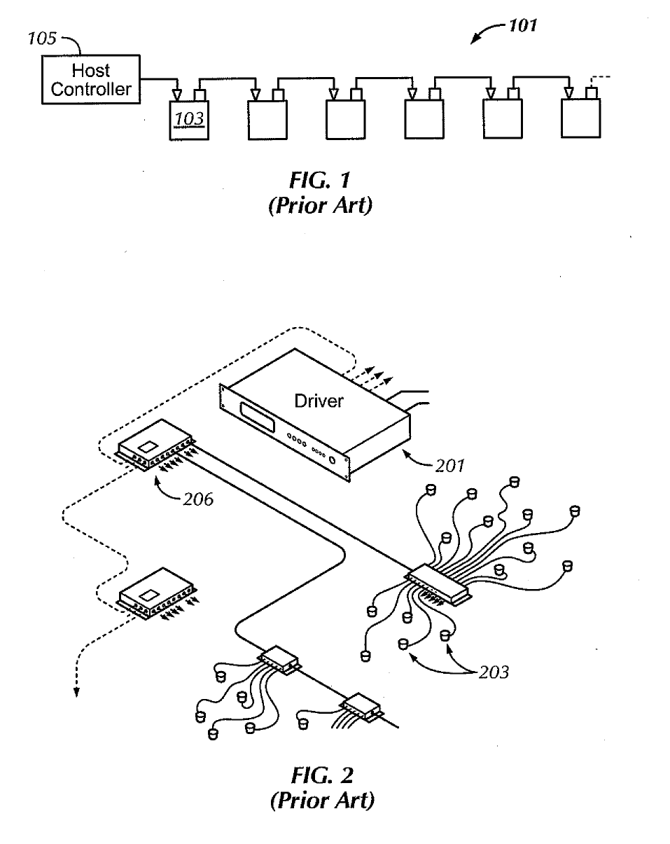

### DETAILED DESCRIPTION

Specific embodiments of the present invention will now be described in detail with reference to the accompanying figures. Like elements in the various figures may be denoted by like reference numerals for consistency.

In one aspect, embodiments disclosed herein relate to a light-emitting apparatus with at least two pixel nodes connected in parallel. The pixel nodes each include functional units that enable communication, controlling, and driving of a light-emitting element located in each pixel node. In another aspect, embodiments disclosed herein relate to functional units and a light-emitting element disposed within a highly integrated circuit. In yet another aspect, embodiments disclosed herein relate to a wire interface. The wire interface enables data signals and power signals to be sent between pixel nodes and host controllers. In another aspect, embodiments disclosed herein relate to a frame having a plurality of pixel locations, in which the pixel locations enable data signals and power signals to be sent to specific pixel nodes disposed within the frame.

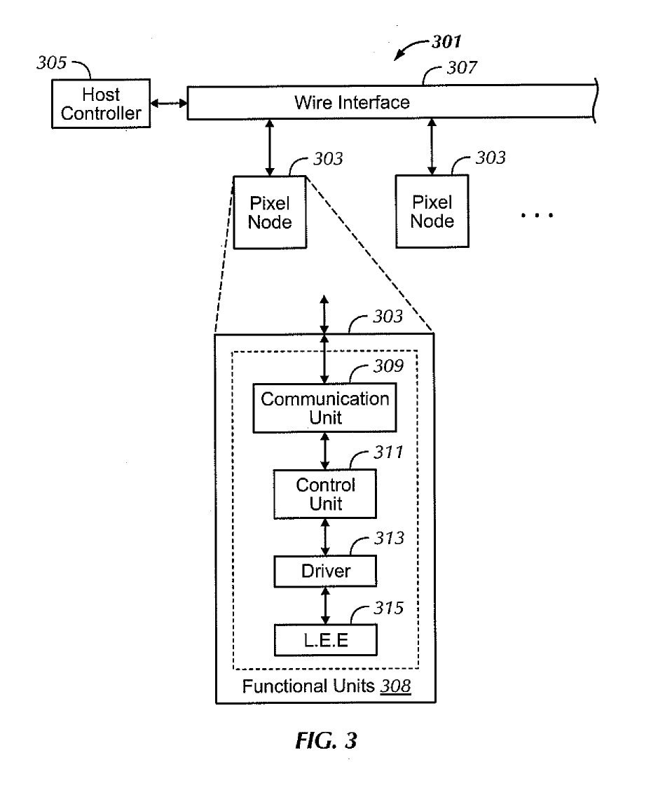

Referring now to FIG. 3, a diagram of a light-emitting display driver architecture 301 in accordance with embodiments disclosed herein is shown. The light-emitting architecture 301 includes a host controller 305 electrically connected to a wire interface 307. Further, a plurality of pixel nodes 303 are electrically connected to the wire interface 307 in parallel. The host controller 305 may provide, or broadcast, a data signal (not shown) that propagates along the wire interface 307. As such, the pixel nodes 303 connected to the wire interface 307 may receive the data signal provided from the host controller 305.

Further, the host controller 305 may also provide a power signal (not shown) along the wire interface 307. This power signal may then be used to power the pixel nodes 303 and elements (e.g., functional units 308) thereof. As such, a power supply (not shown) may be included within the host controller 305 to provide the power signal, or may be a separate from the host controller 305. In another embodiment, multiple power supplies may be electrically connected in different locations of the light-emitting display driver architecture 301. For simplicity within this description, the host controller 305 will provide the power signal in the remaining embodiments, but a person of ordinary skill in the art will appreciate, as discussed above, that this arrangement could vary.

Continuing with FIG. 3, each pixel node 303 contains a plurality of functional units 308. Specifically, the functional units 308 include a communication unit 309, a control unit 311, a driver 313, and a light-emitting element 315. As shown, the communication unit 309 connects to the control unit 311, the control unit 311 connects to the driver 313, and the driver 313 connects to the light-emitting element 315. However, those having ordinary skill in the art will appreciate that the functional units may have other arrangements within the pixel node. Regardless, using the light-emitting display driver architecture 301, the data signal provided from the host controller 305 is provided to each pixel node 303 to ultimately drive the light-emitting element 315. As such, in one embodiment, the host controller 305 may be a media server that provides data signals (e.g., video signals) to be displayed using the light-emitting display driver architecture 301.

Because the pixel nodes 303 are connected in parallel to the wire interface 307 to the host controller 305, the pixel nodes 303 are not dependent on neighboring pixel nodes 303 for any reason. For example, if any one of the pixel nodes 303 may catastrophically fail, be purposely turned off, be taken out, or for any other reason generally stop functioning, the remaining pixel nodes 303 in the light-emitting driver architecture 301 may continue to function as intended. This may, therefore, provide advantages over more typical arrangements, such as a daisy chain arrangement (i.e., series arrangement). In the other arrangements, if any one node stops functioning, or begins functioning incorrectly, any associated or neighboring nodes may be affected and, in some cases, also cease to function correctly. Further, the parallel arrangement of the pixel nodes 303 may also allow for a single data signal to be sent from a host controller 305. This may allow for simple wiring within the wire interface 307, thereby making the wire interface 307 less burdensome and less error prone. Furthermore, because only a single data signal may be propagating on the wire interface 307 from a host controller 305, any multi-signal interference may be reduced, if not all together avoided.

As shown above, each pixel node 303 may comprise the functional units 308 of the communication unit 309, the control unit 311, the driver 313, and the light-emitting element 315. As such, the communication unit 309 may communicate (i.e., send and/or receive data signals) with the host controller 305 or other pixel nodes 303, and the control unit 311 may control and process received data signals into control signals. The control signals from the control unit 311 may then control the driver 313 to drive (i.e., selectively turn on-and-off, vary light color or intensity) the light-emitting element 315. This arrangement of the functional units 308 within the pixel nodes 303 may allow for the host controller 305 to provide a single data signal along the wire interface 307. As such, this greatly decreases the complexity of the host controller 305. Further, with each node 303 having this arrangement of the functional units 308, each pixel node 303 may have the capability to operate independent of all other pixel nodes 303.

Those having ordinary skill in the art will appreciate that, although embodiments disclosed herein are only shown with one light-emitting element disposed on and electrically connected to each pixel node, the invention is not so limited. In other embodiments, multiple light-emitting elements, such as multiple LEDs, may be disposed on each pixel node. In such a case, the LEDs may emit different colors, such as red, green, and blue, as is common for a pixel node comprised of LEDs.

Further, the pixel node 303 may contain the functional units 308 within an integrated circuit, such as a highly integrated circuit. For example, the integrated circuit may be an application-specific integrated circuit (ASIC), a field programmable gate array (FPGA), a complex programmable log device (CPLD), system-on-chip (SOC) design, or any other integrated circuit well known in the art. The integrated circuit having the functional units 308 allows each pixel node 303 to be very compact, dense, and small. As a benefit, the light-emitting element 315 within the pixel node 303 may then be a larger portion of the overall pixel node 303. Further, the use of this integrated circuit may allow for each pixel node to be placed within very close proximity while still providing the benefit of a simple wire interface. Those having ordinary skill in the art will appreciate that not all of the functional units need be included within the integrated circuit. Rather, benefits from using the integrated circuit may be seen by incorporating at least one of the functional units, such as a larger or more complex functional unit, within the integrated circuit.

Furthermore, the pixel nodes may also be placed a greater distance from each other because no longer are they limited by the distance to any of the global functional units. For example, in the prior art, a light-emitting display driver architecture may only incorporate one driver and one control unit to control all of the pixel nodes and light-emitting elements of the architecture. As such, it may be expensive and impractical to boost the signals from both the driver and the control unit, in addition to any other data signals and power signals, along the path from one pixel node to the next pixel node. However, by incorporating the functional units, as shown in FIG. 3, into each of the pixel nodes, the need for unnecessary boosters and equipment to assist the light-emitting display driver architecture may be reduced. In such an embodiment, only the data signal propagation distance and the power supply propagation distance may limit the distance between nodes, rather than boosting any other additional unnecessary signals. However, it is well know in the art that both the data signal and the power signal could easily be boosted at any point with, for example, a repeater circuit.

As such, including the functional units within the pixel node into an integrated circuit may allow for a simpler design process of the light-emitting display driver architecture. For example, the amount and/or complexity of the data sent between the host controller and the pixel nodes is reduced, thereby reducing or eliminating any need for internal data buss lines for communication.

In one embodiment, when a single data signal is sent from the host controller 305 along the wire interface 307, each pixel node 303 may be configured to extract a portion of the data signal from the wire interface 307 corresponding to each pixel node 303. As such, this may possible because each pixel node 303 has a unique address associated with each pixel node 303. The unique address corresponds to a specific portion of the data signal that the host controller 305 is broadcasting along the wire interface 307. Therefore, in one embodiment, the communication unit 309 of the pixel node will enter a listening mode in which the communication unit 309 reads, or listens to, the data signal that is propagating from the host controller 305 on the wire interface 307. Upon reading data from the data signal that corresponds to the pixel node 303, the communication unit 309 will extract or relay the corresponding data portion to the remainder of the pixel node 303, such as the control unit 311 of the pixel node 303, so that the pixel node 303 may process the data signal portion and drive the light-emitting element 315 according to the data signal.

In one embodiment, the unique address is assigned to the pixel node 303 based on a discovery process mode for the host controller 305. In this mode, the host controller 305 may send a request to all, or a selection, of the pixel nodes 303, thereby requesting that each pixel node 303 return a pixel node signal containing a fixed unique identification (ID) of the pixel node 303 (discussed further below). In another embodiment, when a pixel node 303 is positioned or installed within the light-emitting display driver architecture 301, the pixel node 303 may then send the pixel node signal along the wire interface 307 to the corresponding host controller 305. As such, the host controller 305 may then send back to the pixel node 303 the unique address, thereby enabling the pixel node 303 to extract the associated data portion from the data signal that the host controller 305 broadcasts on the wire interface 307.

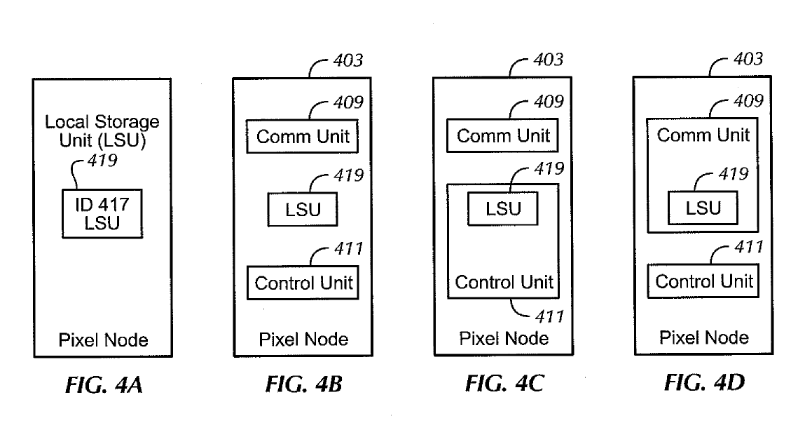

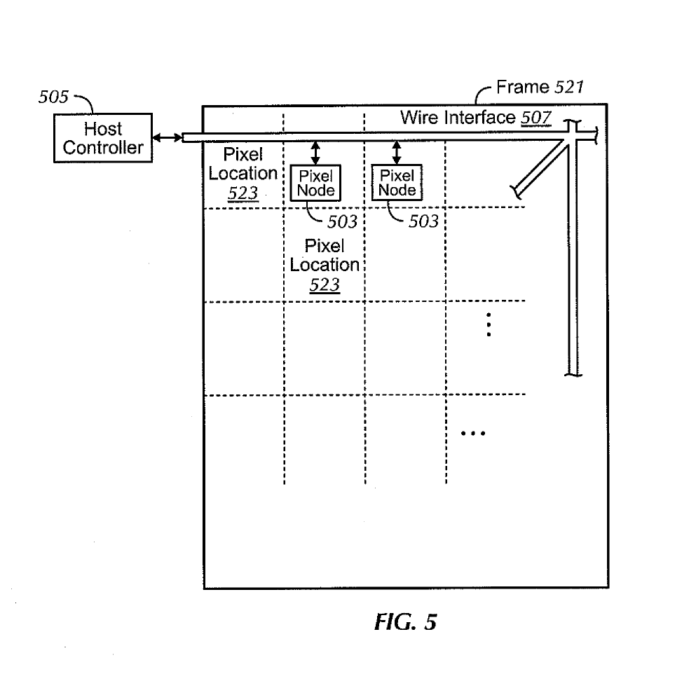

Referring now to FIGS. 4A-D, pixel nodes 403 that include a fixed unique ID 417 in accordance with embodiments disclosed herein are shown. Specifically, as shown in FIGS. 4A-D, the pixel node 403 may have a local storage unit 419 connected to the pixel node 403 to provide the fixed unique ID 417 to the pixel node 403. In FIGS. 4A and 4B, the local storage units 419 may be disposed within the pixel nodes 403 to provide the fixed unique IDs 417. Further, in another embodiment, as shown in FIGS. 4C and 4D, the local storage unit 419 may be included within a functional unit of the pixel node 403. In FIG. 4C, the local storage unit 419 is included within the control unit 411. Similarly, in FIG. 4D, the local storage unit 419 is included within the communication unit 409. Including the local storage unit within the functional units of the pixel node may reduce the amount of internal wires and connections of the pixel nodes. Furthermore, in other embodiments, rather than including the local storage unit 419 within the pixel node 403, the local storage unit may be outside of the pixel node 403 and only electrically connected to the pixel node 403 to provide the fixed unique ID 417. Regardless, the local storage unit may be read-only memory (ROM) (e.g., programmable ROM, erasable programmable ROM, flash electrically erasable programmable ROM), may be a static or dynamic memory bank (e.g., random access memory, flash), or any other local storage unit known in the art. In another embodiment, during manufacture, the pixel nodes 403 may have the fixed unique ID permanently assigned within permanent memory, similar to how a MAC address is used in ethernet network cards. The fixed unique ID may provide the advantage of allowing simple automatic configuration of the light-emitting display driver architecture when used in the field.

Further, rather than defining the fixed unique ID with a local storage unit connected to the pixel node, the fixed unique ID 417 may be defined by a physical feature of the pixel node. For example, the pixel node may have a unique radio frequency identification, a unique reflective surface (e.g., bar code), a unique resistor, a unique capacitance value, a unique groove or bump structure, or any other well known physical feature known in the art that may identify the pixel node. The physical feature may then be detected by a functional unit electrically connected to the pixel node whenever the fixed unique ID is used for identification.

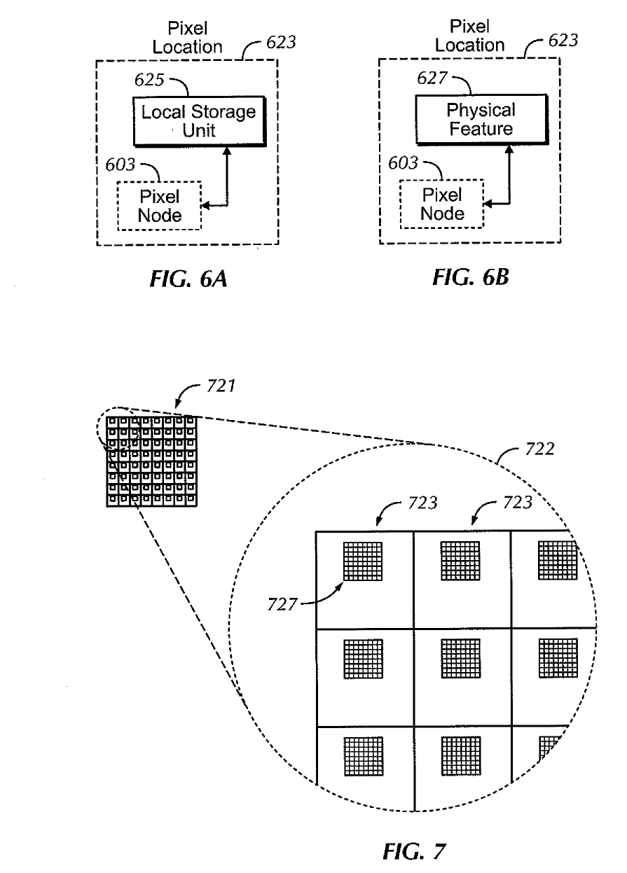

Further, the fixed unique ID may be defined by a physical feature of the pixel location which is identified by the pixel node. This may provide the advantage that all pixel nodes may be manufactured completely identically and interchangeably. Referring now to FIG. 5, a frame 521 having a plurality of pixel locations 523 in accordance with embodiments disclosed herein is shown. In this embodiment, a wire interface 507 is integrated with the frame 521. Specifically, the wire interface, which is electrically connected to a host controller 505 and pixel nodes 503, may be disposed on, within, or adjacent to the frame 521. The pixel nodes 503 may then electrically and mechanically connect to the frame 521 at the pixel locations 523. As such, once the pixel node 503 is connected to the frame 521, the pixel node 503 may acquire a fixed unique ID included within the pixel location 523. For example, in FIG. 6A, a local storage unit 625 may be located within a pixel location 623 to define the fixed unique ID at the pixel location 623. Further, in FIG. 6B, a physical feature 627 may be located within the pixel location 623 to define the fixed unique ID.

Referring now to FIGS. 7-10, frames having physical features within the pixel locations to define fixed unique IDs in accordance with embodiments disclosed herein are shown. The pixel locations may each have a fixed unique ID (e.g., a spatially encoded ID), in which an individual pixel node address based on the fixed unique ID is provided by the host controller. For example, when the physical feature of the pixel location defines the fixed unique ID to the pixel node, the pixel node may send a signal to the host controller with fixed unique ID to the host controller, in which the host controller would respond back to the pixel node with the address of the pixel node. As described above, the address of the pixel node may then be used to extract a portion from the data signal that corresponds to the pixel node.

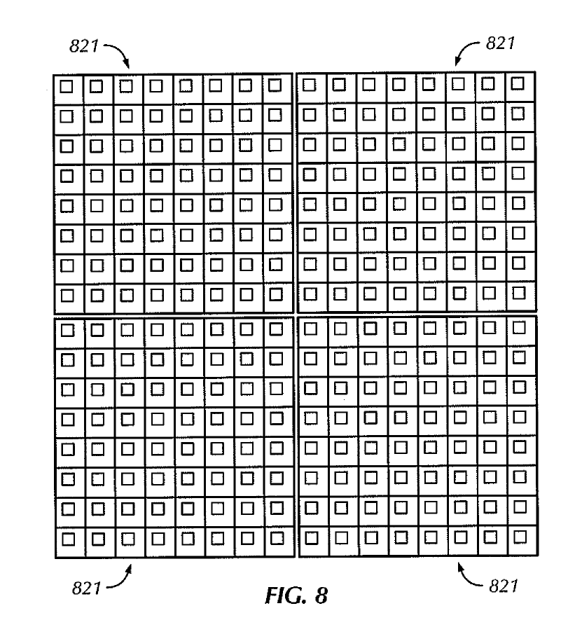

In FIG. 7, an illustration of a frame 721 with a detail of the upper left corner 722 in accordance with embodiments disclosed herein is shown. In this embodiment, the pixel locations 723 each include the physical feature of an ID box 727 (e.g., an 8×8 ID box, as shown). With the ID box 727, a large number of fixed unique IDs may be encoded into each pixel location by a user physically altering the ID box 727. For example, each ID box 727 may be unique by altering different portions of the ID box to define a unique fixed unique ID. Further, the ID box 727 may be divided into several zones so as to indicate a frame, a pixel location, or other user selectable information within the ID box. As such, as shown in FIG. 8, multiple frames 821 may be incorporated together to form a larger overall display. Further, one of ordinary skill in the art would appreciate that the frames, and the combination of frames, may be arranged in arrangements other than a simple grid.

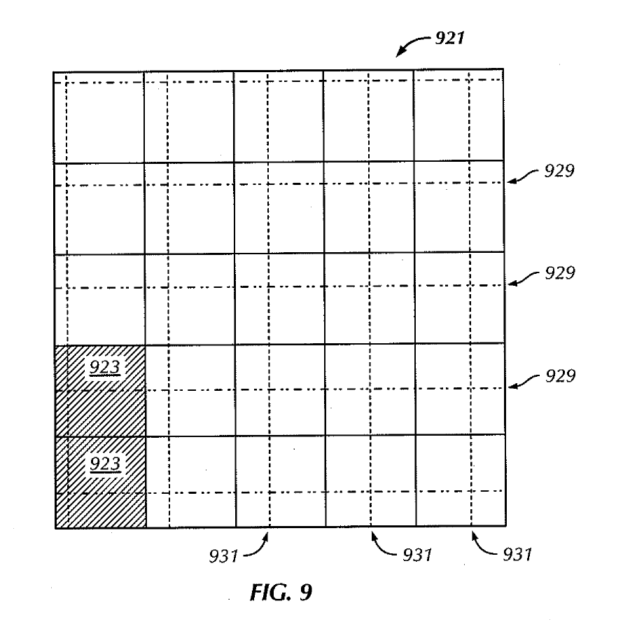

Referring now to FIG. 9, for another physical feature to define the fixed unique IDs at pixel locations 923, a frame 921 may include horizontal wires 929 and vertical wires 931 disposed across the frame 921. The wires 929 and 931 may be, for example, disposed across the back of the frame 921, or may also be laminated into a fabric within the frame 921. Regardless, with frame 921 and pixel locations 923, insulation displacement connectors (IDC) may be incorporated with the pixel nodes. The IDC with each pixel node will have multiple contacts disposed thereon to connect with the wires 929 and 931. Most of the contacts of the IDC would not connect with the wires 929 and 931. However, the connections with the wires 929 and 931 that do complete a circuit are arranged in such a manner that multiple unique IDs for the pixel locations 923 may be determined and achieved. Further, rather than only having horizontal and vertical wires 929 and 931, those having ordinary skill in the art will appreciate that any arrangement of the wires may be used to define the fixed unique IDs of the pixel locations 923.

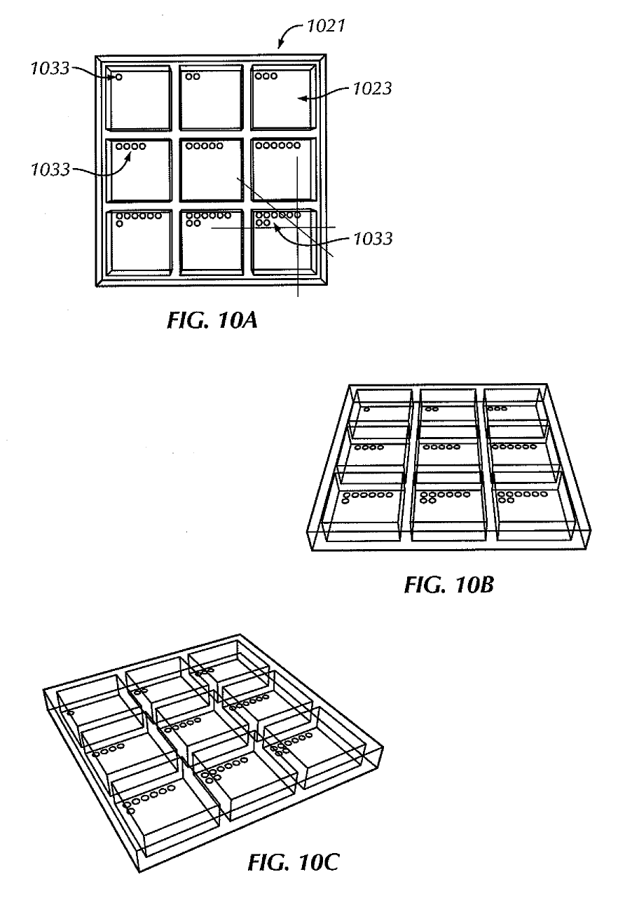

Referring now to FIG. 10, for another physical feature to define the fixed unique IDs at the pixel locations, a frame 1021 at each pixel location 1023 may include a combination of holes 1033. Each combination of holes 1033 corresponds to a fixed unique ID at the pixel location 1023. As such, each pixel node may have a multiple tensioned contacts, in which some of the tensioned contacts would connect with the pixel location 1023 and others would protrude through at the holes 1033. The specific arrangement of the tensioned contacts that connect at the pixel location 1023 would define the fixed unique ID at the pixel location 1023.

Further, those having ordinary skill in the art will appreciate that other physical features may be used to define the fixed unique ID at the pixel locations. For example, in one embodiment, each pixel location may include a conductor with a path to a Ground. A variance in electrical characteristics of an internal circuit may then be used to define the fixed unique ID of the pixel location. Further, in another embodiment, each pixel location may include a physical indentation system to define the fixed unique ID. The indentations may be bumps, perforations, grooves, a raised area on a flat surface, any combination thereof, or any other indentations known in the art. Furthermore, the pixel locations may include metal slugs that the pixel node is capable of detecting using signal processing techniques known in the art. Furthermore still, the pixel locations may include magnetic elements that the pixel node is capable of detecting, such as by using signal processing techniques known in the art, including, but not limited to, Hall Effect sensors. Furthermore still, the pixel locations may include a small infra-red (IR), ultra-violet (UV), or visible light emitter to illuminate a unique pattern at the pixel location. An IR receiver included within the pixel node may detect the unique pattern illuminated to determine a fixed unique ID from the IR emitter at the pixel location.

In another embodiment, the host controller may then store the fixed unique IDs in a routing record. The routing record may then be used to map the wiring of the display architecture. The routing record may be used for trouble shooting and to enable the system to route around any problems, such as catastrophic driver failures and cut or disconnected cables.

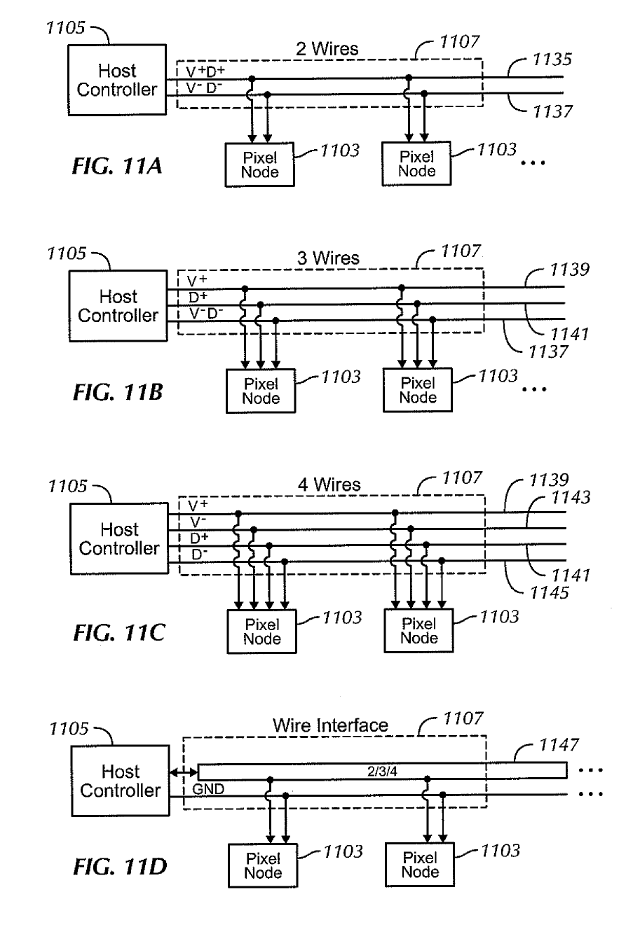

Referring now to FIGS. 11A-D, multiple arrangements of a wire interface 1107 in accordance with embodiments disclosed herein are shown. In FIG. 11A, a two-wire system for the wire interface 1107 is shown, in which the wire interface 1107 includes a first wire (V+D+) 1135 and a second wire (V−D−) 1137. Both wires 1135 and 1137 are electrically connected to a host controller 1105. Further, multiple pixel nodes 1103 connect to both wires 1135 and 1137 of the wire interface 1107 in parallel. This embodiment allows for both a data signal and a power signal to be sent across the same wires. This is facilitated by using differential signaling. Differential signaling is a method of transmitting information electrically with two complementary signals sent on two separate wires. The technique may be used for both analog signaling, as in some audio systems, and digital signaling, as in American National Standard 422 (Electronic Industries Alliance EIA-422, formerly Radio Standard 422, RS-422), American National Standard 485 (EIA-485, formerly RS-485), Peripheral Component Interconnect (PCI) Express, and Universal Serial Bus (USB). Other examples for differential signaling include low-voltage differential signaling (LVDS), differential Emitter Coupled Logic circuit (ECL), Positive Emitter Coupled Logic (PECL), Low Voltage Positive Emitter Coupled Logic (LVPECL), EIA-422, EIA-485, serial Advanced Technology Attachment (ATA), FireWire, and High-voltage differential signaling (HVD).

Regardless, when the host controller 1105 sends the data signal, the data signal is split into a two components (e.g., the D+ and D− components) and sent over the two wires 1135 and 1137. The pixel node 1103 then may receive a difference between the two components, thereby acquiring the data signal. In such a configuration, the pixel node 1103 may ignore the power signal (e.g., the V+ and V− components) with respect to Ground to provide a tolerance for a Ground offset. As such, minor changes in Ground potential between the host controller 1105 and the pixel node 1103 may not affect the data signal being received by the pixel node 1103. For example, when grounding, the wires 1135 and 1137 may have the same impedance to Ground, so any interfering fields or currents may induce the same voltage in both wires 1135 and 1137. Because the pixel node 1103 may only receive or read the difference between the wires 1135 and 1137 when acquiring the data signal, the wire interface 1107 may not be affected. In a similar embodiment, the pixel node 1103 may be sending a pixel node data signal using differential signaling, in which the host controller 1105 may be receiving the differential pixel node data signal.

In FIG. 11B, a three-wire system for the wire interface 1107 is shown, in which the wire interface 1107 includes a V−D− wire 1137, a V+ wire 1139, and a D+ wire 1141.

All three wires 1137, 1139, and 1141 are electrically connected to the host controller 1105 and the pixel nodes 1103 are connected in parallel across the three wires 1137, 1139, and 1141. This embodiment may also use differential signaling for the data signal, in which the D+ and the V+ signal are sent on individual wires 1139 and 1141. This may be useful when accommodating for a more powerful or noisy V+ component of the power signal.

In FIG. 11C, a four-wire system for the wire interface 1107 is shown, in which the wire interface 1107 includes a V+ wire 1139, a D+ wire 1141, a V− wire 1143, a D− wire 1145. In this embodiment, a separation between the power wires 1139 and 1143 and the data signal wires 1141 and 1145 may be achieved. This may allow for the data signal wires 1141 and 1145 and the power signal wires 1139 and 1143 to be shielded and/or wired differently. Further, in the case of a wire interface 1107 failure, only one wire or set of wires may need to be replaced. For example, the generally cheaper, yet more fragile, data signal wires 1141 and 1145 may only need to be replaced to correct the wire interface 1107 failure, in which the more expensive power signal wires 1139 and 1143 will remain unaffected and intact.

In FIG. 11D, the wire interface 1107 further includes an additional Ground (GNU) wire 1147 electrically connected to the host controller 1105. Such an arrangement may provide the benefit of installing a special signal Ground known as a “technical Ground” (or “technical earth”). Further, another potential use and benefit of the Ground wire 1147 may be as a power Ground, serving to provide a return path for fault currents and, therefore, allow a fuse or breaker to disconnect the circuit.

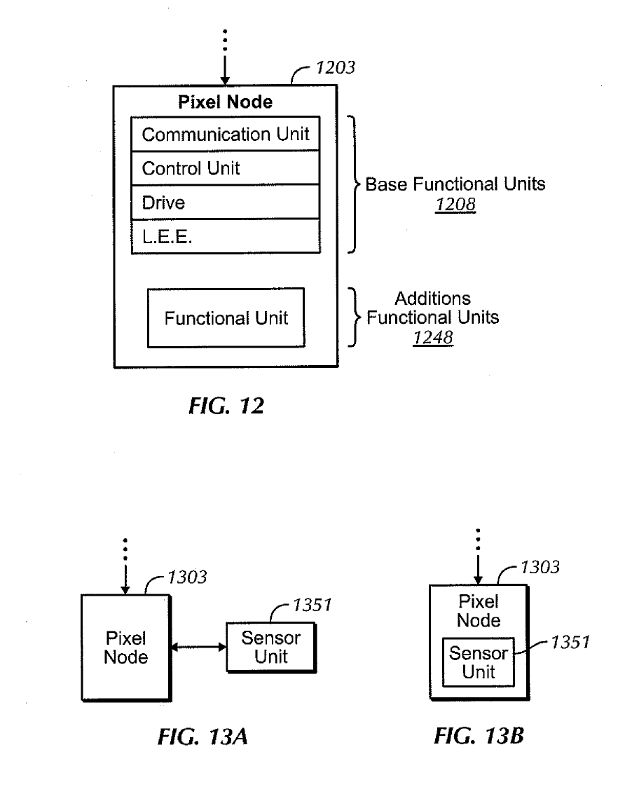

As described above, the pixel nodes may include functional units such as the communication unit, the control unit, the drive unit, and the light-emitting element. However, in another embodiment, as shown in FIG. 12, a pixel node 1203 may contain additional functional units 1248 in addition to functional units 1208 already described from above. As such, examples for the additional functional units 1248 that may be included within one or more of the pixel nodes 1203 may be a voltage regulator, and external memory, a OSC, an arithmetic logic unit (ALU), a floating point unit (FPU), or any other functional unit known in the art.

Further, another embodiment may include an additional storage unit for the additional functional unit 1248. This additional storage unit may, for example, store data to be displayed by the corresponding pixel node. This may also allow the host controller to offline upload data to the pixel units. Thus, the data does would not have to be uploaded all in real time. Also, if there is data that is frequently reused, the data may be stored in the storage unit and, rather than transferred from the host controller multiple times, may simply send a command to pull the reusable data from the additional storage unit of the pixel node. Thus, such an additional storage unit may provide the advantage of saving bandwidth and allowing offline data transfers.

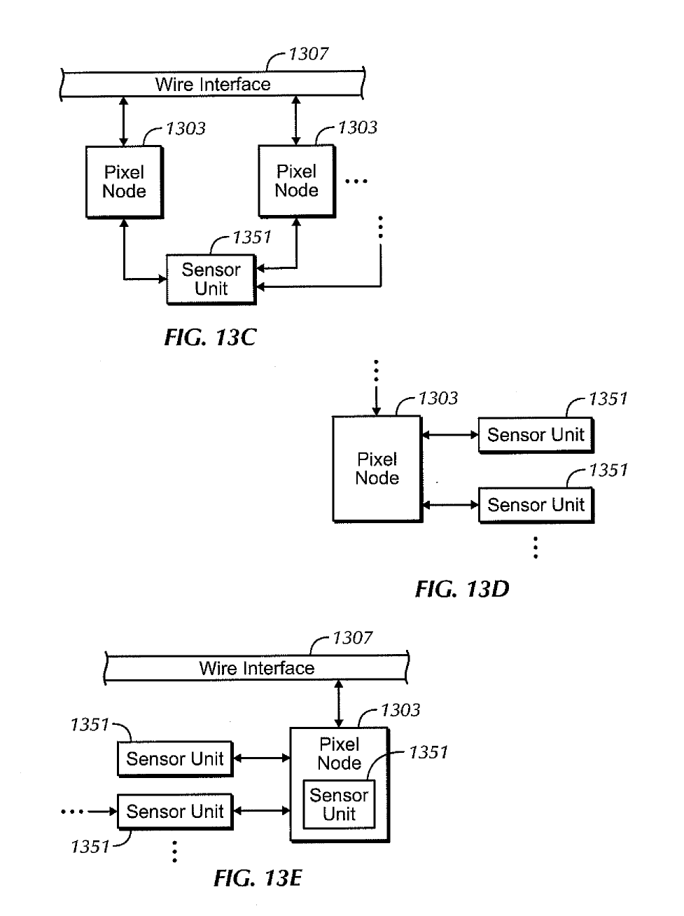

Referring now to FIGS. 13A-D, a pixel node 1303 may include a sensor unit 1351 electrically connected thereto as an example of an additional functional unit in accordance with embodiments disclosed herein. The sensor unit 1351 may be a thermal sensor (e.g. thermocouples, temperature sensitive resistors (thermistors and resistance temperature detectors)), an electromagnetic sensor (e.g. electrical resistance, current, voltage, and power sensors), a mechanical sensor (e.g. contact switch, pressure sensor), a chemical sensor (e.g. ion-selective electrodes, pH glass electrodes, and redox electrodes), an optical sensor (e.g. photodetectors including photocells, photodiodes, phototransistors, CCDs, infra-red, and image sensors), an acoustic sensor (e.g. microphone), a motion sensor, an orientation sensor (e.g. gyroscope), a magnetic sensor (e.g. Hall effect device) or any other sensor known in the art. As such, the sensor unit 1351 could provide information about the environment surrounding to the pixel node 1303.

As shown in FIG. 13A, the sensor unit 1351 may be external to the pixel unit 1303 and still remain electrically connected. This may allow for the sensor 1351 unit to be located at a position to be acquire a sensor input signal without being restricted by the placement of the pixel node to which the sensor unit 1351 is electrically connected. Further, as shown in FIG. 13B, the sensor unit 1351 may be included within the pixel node 1303. This arrangement of the sensor unit 1351 may allow for further integration within the pixel node 1303. For example, the sensor unit 1351 may be included within another functional unit or as part of the integrated circuit within the pixel node 1303. Furthermore, as shown in FIGS. 13C-E, a pixel node 1303 may include one or more sensor units 1351 electrically connected thereto, or a sensor unit 1351 may be electrically connected to more than one pixel node.

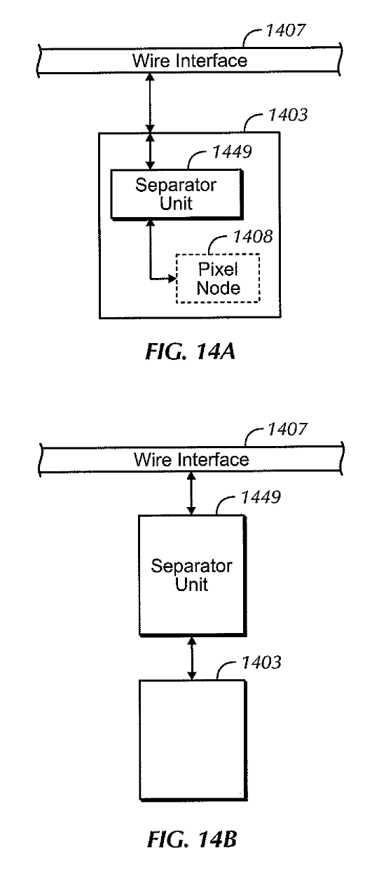

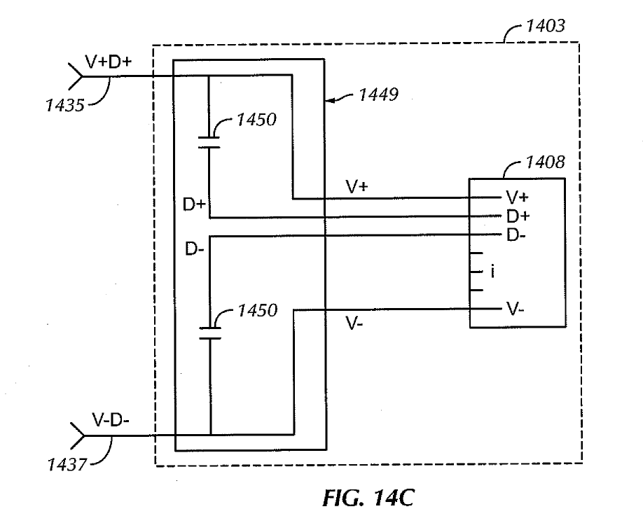

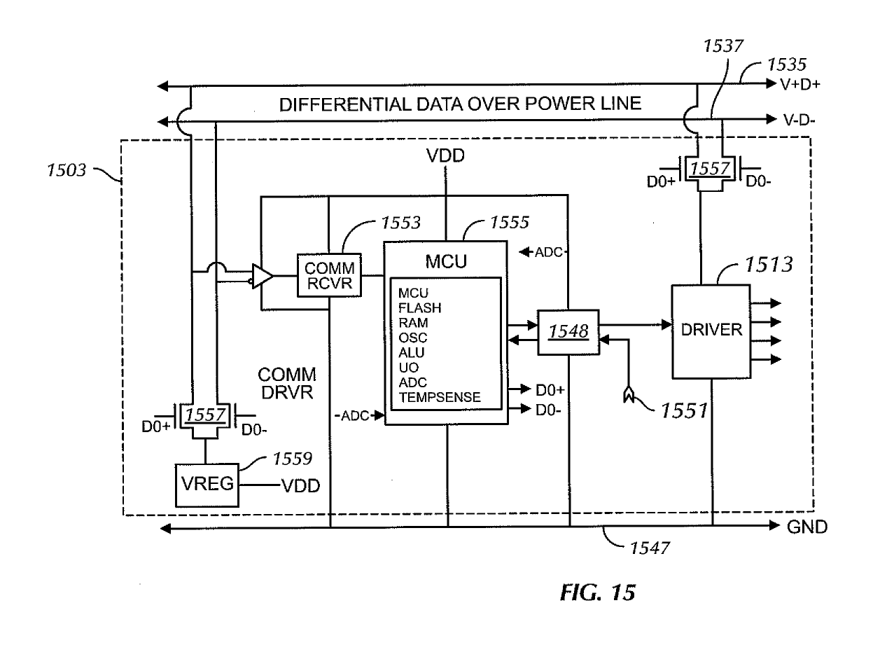

Referring now to FIGS. 14A-C, a pixel node 1403 may include a separator unit 1451 electrically connected thereto as another example of an additional functional unit in accordance with embodiments disclosed herein. As shown in FIGS. 14A and 14B, the separator unit 1449 may be included within the pixel node 1403 when electrically connected thereto, or may be external to the pixel node 1403 when electrically connected thereto. FIG. 14C then shows a more detailed view of a separator unit 1449 including a filter system 1450. In this embodiment, a first wire (V+D+) 1435 and a second wire (V−D−) 1437 provide a data signal and a power signal from a host controller (not shown) to the pixel node 1403. The filter system 1450, such as a capacitance filter system, may filter out and separate the data signal from the two wires 1435 and 1437, as shown in FIG. 14C.

Referring now to FIGS. 15-17, specific embodiments and arrangements of the internal architecture of pixel nodes 1503, 1603, and 1703 in accordance with embodiments disclosed herein are shown. In FIG. 15, the pixel node 1503 electrically connects to a two-wire interface having a V+D+ wire 1535, a V−D− wire 1537, in addition to a GND wire 1547. Each pixel node 1503 is connected to these three wires 1535, 1537, and 1547 in parallel. Specifically, within the pixel node 1503, a communication unit 1553 (e.g., communication receiver) is connected across the wires 1535 and 1537 and extracts a data signal carried along the wires 1535 and 1537 into a Micro-Controller Unit (MCU) 1555. Further, using voltage steering units 1557 and a voltage regulator unit 1559, the power signal carried along the wires 1535 and 1537 may be provided to the pixel node 1503 and any elements thereof. The MCU 1555 may then be used to control the voltage steering units 1557 to route the power signal accordingly within the pixel node 1503.

The MCU 1555 and/or additional functional units 1548 within the pixel node 1503 may also produce control signals to control drivers 1513. The outputs from the drivers 1513 may then be used to control other functional units of the pixel node 1503, such as light-emitting elements connected to the driver 1513. Further, the MCU 1555 and/or additional functional units 1548 may be provided with inputs 1551, thereby allowing data signals from the functional units 1548 of the pixel node 1503, or external sensor units, to be routed back to the MCU 1555. As such, the MCU 1555 may require logic and/or further functional units disposed within the MCU 1555 or electrically connected thereto, such as Read-only-Memory (ROM), Flash Memory, Random Access Memory (RAM), Frequency Oscillators (OSC), Arithmetic Logic Units (ALU), Digital Signal Processors (DSP), Input/Output circuitry (I/O), Analogue to Digital converters (ADC), Digital-to-Analogue converters (DAC), Temperature Sense elements (TEMPSENSE), Pulse Width Modulation outputs (PWM), in addition to any other elements known in the art.

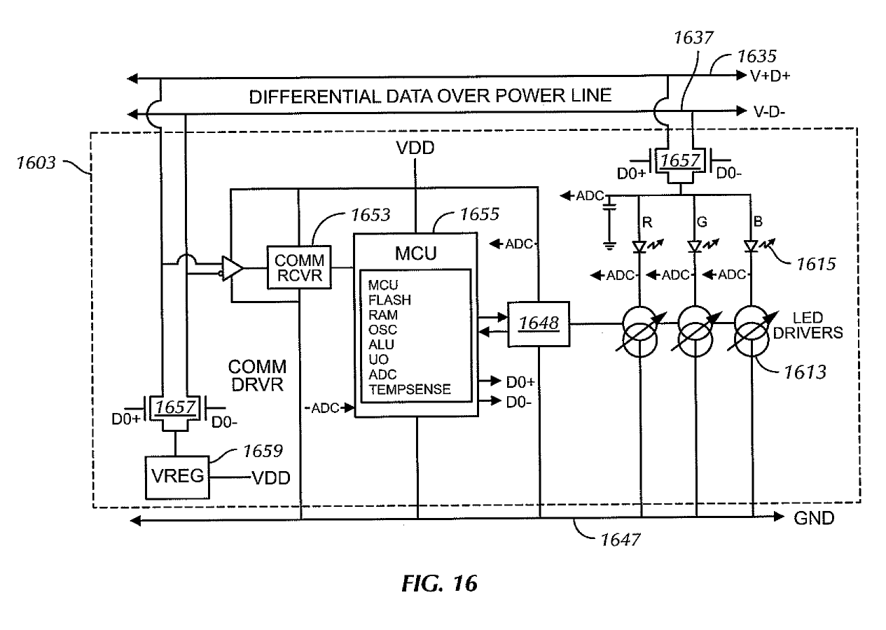

FIG. 16, similarly, shows a pixel node 1603 electrically connected to a two-wire interface having a V+D+ wire 1635, a V−D− wire 1637, in addition to a GND wire 1647. However, in this embodiment the MCU 1655 controls a multiple PWM element 1648, rather than a more generic functional unit. The PWM element 1648 may provide control signals to multiple LED drivers 1613, in which the LED drivers may drive the LEDs 1615, as shown. Although three LEDs 1615 are shown in FIG. 16, the invention is not so limited, and those having ordinary skill in the art will appreciate that any number of PWM elements 1648, drivers 1613, and LEDs 1615 (i.e., light-emitting elements) may be utilized.

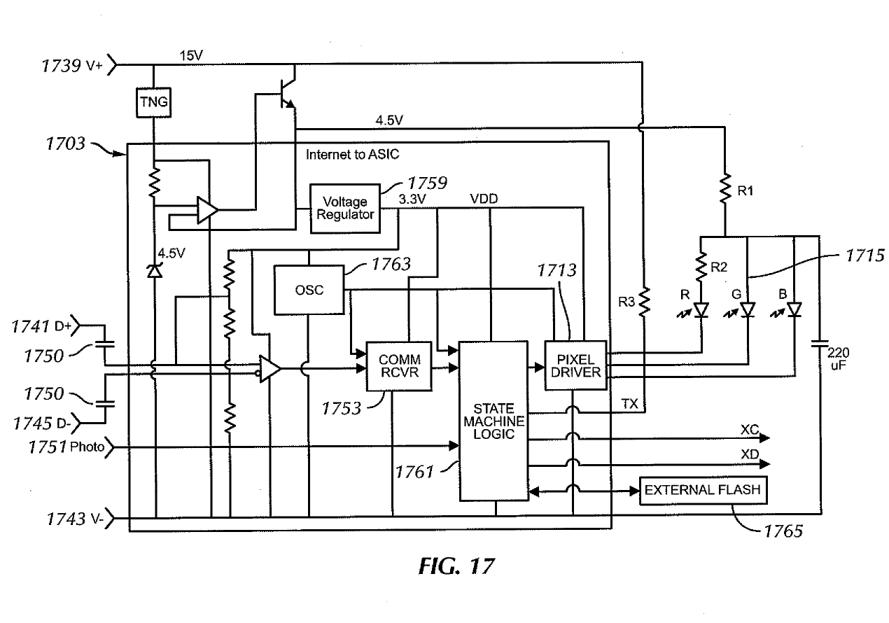

Similarly still, FIG. 17 shows another pixel node 1703 which electrically connects to a wire interface. However, in this embodiment, rather than a two-wire interface, the pixel node 1703 electrically connects to a four-wire interface having a V+ wire 1739, a D+ wire 1741, a V− wire 1743, and a D− wire 1745. In this embodiment, the functional units of the pixel node 1703 are integrated within an ASIC. Further, the data signal and the power signal are distributed over the four wires 1739, 1741, 1743, and 1745, with the power signal on wires 1739 and 1743, and the data signal on wires 1741 and 1745. As shown in this embodiment, the V− wire 1743 may also provide a Ground connection GND.

Further, in this embodiment, a communication unit 1753 is connected across the data wires 1741 and 1745 to extract the data signal for a state machine logic unit 1761. The state machine logic unit 1761 then controls the reception of the data signal from the data wires 1741 and 1745 and parses it into actions. For example, the state machine logic unit 1761 may identify the start of a message, interpret the command code, execute the required command, and restore itself in readiness to receive the next message. Because of the basic operations of the state machine logic unit 1761, the state logic unit may be replaced by an MCU. For example, the state machine logic unit 1761 performs functions similar to the MCU 1555 of FIG. 15 when controlling the pixel node 1703. Thus, in some embodiments, it may be appropriate to use either one of a state machine logic unit or an MCU.

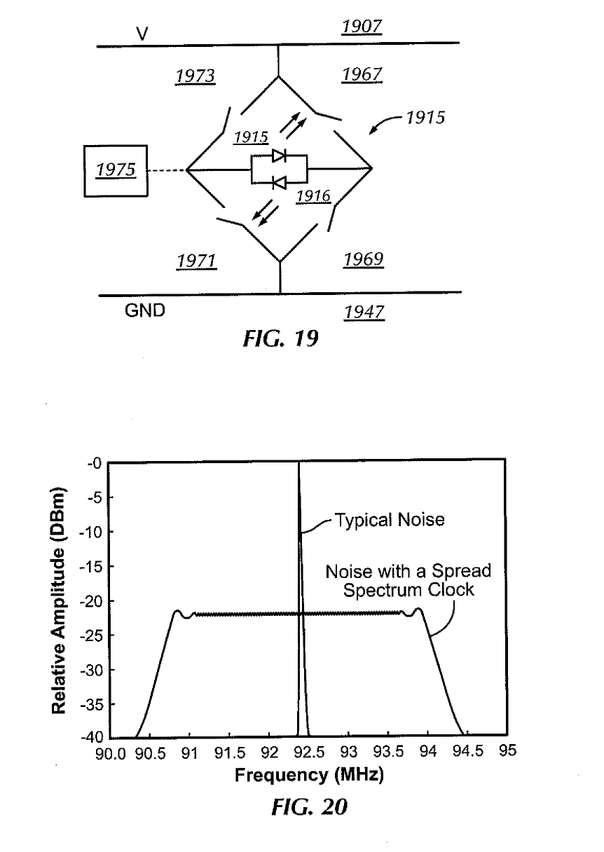

Referring now to FIG. 19, a redundant circuit arrangement with light-emitting elements 1915 and 1916 in accordance with embodiments disclosed herein is shown. Light-emitting elements 1915 and 1916 are connected to a wire interface 1907 through a bridge of switches 1967, 1969, 1971, and 1973. Switches 1967, 1969, 1971, and 1973 are controlled by a controller 1975. The controller 1975 may be a control unit (such as control unit 311 shown in FIG. 3), or may also be the host controller 305. Regardless, during operation, the controller 1975 will selectively open and close the switches 1967, 1969, 1971, and 1973 to allow a signal to pass through and illuminate the light-emitting elements 1915 and 1916. In another embodiment, the controller 1975 may be an additional functional unit, namely a redundant chipset unit, whose sole purpose is to monitor any redundant circuit arrangements and bypass accordingly using the switches 1967, 1969, 1971, and 1973 as explained below.

In such an embodiment, the controller 1975 may be capable of recognizing and routing around failures of any of the switches 1967, 1969, 1971, and 1973 or light-emitting elements 1915 and 1916. For example, if the controller 1975 recognizes that switch 1973 has failed in the open position, then controller 1975 will open switch 1969 and close switch 1971. Switch 1967 may then be opened and closed by controller 1975 to allow current to pass through light-emitting element 1916 as required. Alternatively, if the controller 1975 recognizes that switch 1973 has failed in the closed position, then controller 1975 will open switches 1967 and 1971. Switch 1969 may then be opened and closed by controller 1975 to allow current to pass through light-emitting element 1915 as required. Alternatively still, if the controller 1975 recognizes that light-emitting element 1915 has failed, then controller 1975 will open switches 1973 and 1969 and close switch 1971. Accordingly, switch 1967 may then be opened and closed by controller 1975 to allow current to pass through light-emitting element 1915 as required. As such, controller 1975 may reconfigure the redundant circuit arrangement to compensate for failure in either the opened or closed position of any of the switches 1967, 1969, 1971, and 1973, or failure of either of the light-emitting elements 1915 and 1916.

Those having ordinary skill in the art will appreciate that other schematics and layouts may be constructed to achieve a redundant circuit arrangement as explained herein. For example, rather than having the light-emitting element arranged in a redundant circuit arrangement, any one of the possible functional units, or combination of the functional units, may be arranged in a redundant circuit arrangement. Further, switches 1967, 1969, 1971, and 1973 are here shown diagrammatically as simple switches. However, those having ordinary skill in the art will appreciate that the switches 1967, 1969, 1971, and 1973 may be constructed as any type of switch known in the art, such as metal-oxide-semiconductor field-effect transistors (MOS-FETs).

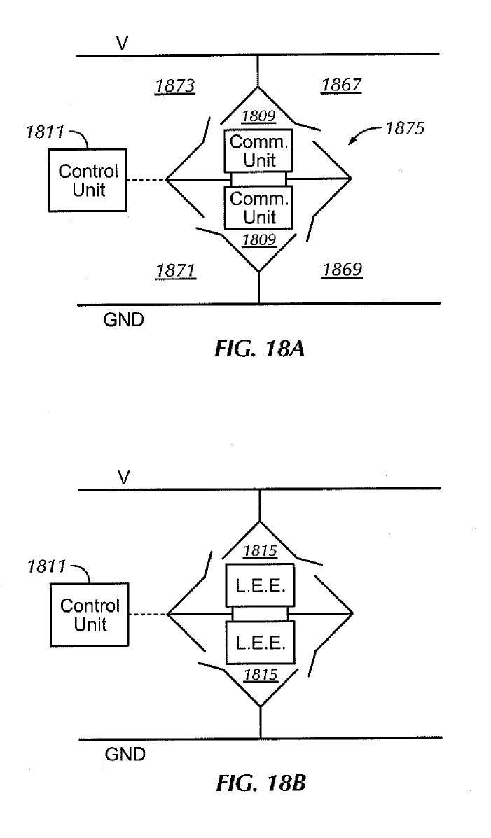

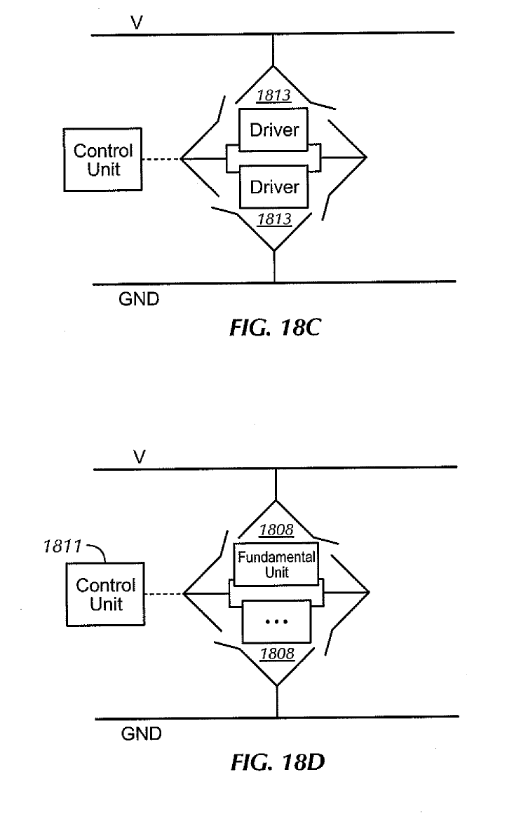

For example, FIGS. 18A-D show additional embodiments of a redundant circuit arrangement incorporating various functional units. In FIG. 18A, a communication unit 1809 is arranged in a redundant circuit arrangement. In FIG. 18B, another light-emitting element 1815 is arranged in a redundant circuit arrangement. In FIG. 18C, a driver 1813 is arranged in a redundant circuit arrangement. In FIG. 18D, multiple functional units 1808 (i.e., communication unit, control unit, driver, light-emitting element) are arranged in a redundant circuit arrangement. In another embodiment, the redundant circuit arrangement may be designed such that the two redundant units may be operated at a variable load, for example each at 50%, and only operate at full load where one of the redundant units has failed.

Another embodiment may use junction points and provide a wire interface with redundant connectivity. Thus, the light-emitting display driver architecture may take advantage of the redundant connectivity of the wire interface and the fixed unique IDs to close any gaps in the data distribution by providing alternate data paths on an active basis during operation of the display. This active redundancy may also provide multiple data signal inputs from multiple host controllers to the wire interface as opposed to the one-in, one-out topology. Thus, failures of data distribution may be mitigated and the display may continue to operate.

In another embodiment, a wire interface topology is chosen such that no single link, wire, or pixel node, is critical to the overall connectivity of the system allowing the use of the fixed unique IDs to enable routing around the failure of any single element. Such an embodiment may further provide protection against multiple simultaneous failures of individual data paths or nodes. In another embodiment, the host controller may dynamically monitor pixel nodes, and/or specific functional units within each pixel nodes (e.g. drivers), and bypass a failed pixel node or functional unit.

Referring now to FIG. 20, a graphical representation showing a dB noise drop using a spread spectrum clock is shown. Typical noise, when incoming, may have large amplitudes (e.g., spikes) that may alter, affect, or even damage a light-emitting display driver architecture. By incorporating a spread spectrum clock as another additional function unit within the pixel nodes, the noise amongst various frequencies may be lowered (e.g., spread). As such, the incoming noise would reduce or eliminate any potential damaging large amplitude noises.

In addition to the above discussed benefits and advantages, embodiments of the present disclosure may provide for one or more of the following advantages. First, embodiments disclosed herein may provide for a light-emitting display driver architecture having a three wire interface (V+D+, V−D−, Ground), rather than the legacy four-wire interface. This may enable the data signal and power signal to be sent over the same wires. Further, differential data signaling may be used in such an embodiment to reduce radio frequency interference (RFI), electromagnetic interference (EMI) emission, and noise sensitivity.

Further, embodiments disclosed herein may provide for a light-emitting display driver architecture having the pixel nodes connect in parallel on the wire interface. This arrangement may help avoid any propagation of errors within the light-emitting display driver architecture. The parallel structure may also be coupled with the bidirectional signaling (host controller-to-pixel node, pixel node-to-host controller, pixel node-to-pixel node) to enable communication in both directions between the host controller and the pixel nodes.

Furthermore, embodiments disclosed herein may provide for a light-emitting display driver architecture having multiple pixel nodes share a common set of functional units. For example, in an embodiment in which a flash memory of a MCU is shared between multiple pixel nodes, the flash memory may provides non-volatile storage of pixel node parameters and may store non-volatile pixel node history data (e.g. black box) and/or power up data (e.g. customer logo).

Finally, embodiments disclosed herein may provide for a light-emitting display driver architecture that has a plurality of functional unit combinations and integrations. Having such a plurality of functional units may allow for the pixel nodes to perform multiple internal functions, including: reset; test pattern; accept unique serial number; self addressing (set relative address in node string array); node monitoring; node aging calculation and monitoring and compensation; node calibration; data demultiplexing from ordered data set in multi-node data field of message; fault monitoring; temperature monitoring; system verification (loop back messaging to controller); video frame sync timing reference (e.g. VSYNC); and video pixel data (e.g. an ordered sequence of data describing pixel node values.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A light-emitting display driver architecture, comprising:
a wire interface;
a host controller electrically connected to the wire interface; and
a first pixel node and a second pixel node connected to the wire interface in parallel,
wherein the first pixel node and the second pixel node each comprise:
a communication unit electrically connected to the wire interface;
a control unit electrically connected to the communication unit;
a driver electrically connected to the control unit; and
a light-emitting element electrically connected to the driver.

2. The light-emitting display driver architecture of claim 1, wherein the first pixel node further comprises a highly integrated circuit, and wherein the communication unit, the control unit, the driver, and the light-emitting element are disposed within the highly integrated circuit.

3. The light-emitting display driver architecture of claim 2, wherein the highly integrated circuit comprises one of an application-specific integrated circuit (ASIC), a field programmable gate array (FPGA), and a complex programmable logic device (CPLD).

4. The light-emitting display driver architecture of claim 2, wherein the highly integrated circuit comprises a printed circuit board (PCB), wherein at least one of the communication unit, the control unit, the driver, and the light-emitting element is disposed on and electrically connected to the PCB.

5. The light-emitting display driver architecture of claim 1, wherein the first pixel node further comprises a fixed unique identification (ID) defined within a local storage unit.

6. The light-emitting display driver architecture of claim 1, wherein the first pixel node further comprises a fixed unique ID defined by a physical feature of the first pixel node.

7. The light-emitting display driver architecture of claim 1, further comprising:
a frame having a first pixel location and a second pixel location, wherein the wire interface is integrated with the frame; and
wherein the first pixel location and the second pixel location each comprise a fixed unique ID;
wherein the first pixel node is disposed at the first pixel location, thereby acquiring the fixed unique ID of the first pixel location; and
wherein the second pixel node is disposed at the second pixel location, thereby acquiring the fixed unique ID of the second pixel location.

8. The light-emitting display driver architecture of claim 7, wherein the fixed unique ID of the first pixel location is defined within a local storage unit or by a physical feature at the pixel location.

9. (canceled)

10. The light-emitting display driver architecture of claim 1, wherein the wire interface comprises a Ground wire and one of a two-wire system, a three-wire system, and a four-wire system.

11. (canceled)

12. The light-emitting display driver architecture of claim 1, further comprising a separator unit electrically connected to the first pixel node.

13. The light-emitting display driver architecture of claim 1, further comprising a sensor unit electrically connected to the first pixel node.

14. The light-emitting display driver architecture of claim 13, wherein the sensor unit comprises one of a thermal sensor, an electromagnetic sensor, a mechanical sensor, a chemical sensor, an optical sensor, an acoustic sensor, a motion sensor, an orientation sensor, and a magnetic sensor.

15. The light-emitting display driver architecture of claim 1, wherein the control unit comprises one of a state machine logic unit (SMLU), a micro-controller unit (MCU), and a general purpose central processing unit (CPU).

16. The light-emitting display driver architecture of claim 1, wherein the driver comprises a light-emitting diode (LED) driver and the light-emitting element comprises a LED.

17. (canceled)

18. The light-emitting display driver architecture of claim 1, wherein at least one of the communication unit, the control unit, the driver, and the light-emitting element are arranged in a redundant circuit arrangement.

19. A method of supplying power and data to a light-emitting display driver architecture, the method comprising:
transmitting a power signal and a data signal from a host controller through a wire interface to a first pixel node and a second pixel node connected in parallel across the wire interface;
extracting data from the data signal with the first pixel node based upon a fixed unique ID corresponding to the first pixel node; and
controlling a driver and a light-emitting element of the first pixel node based upon the extracted data.

20. The method of supplying power and data of claim 19, further comprising:
transmitting a sensor signal from a sensor unit to the first pixel node; and
controlling the driver and the light-emitting element of the first pixel node based upon the sensor signal.

21. The method of supplying power and data of claim 19, wherein the first pixel node further comprises the fixed unique ID defined within a local storage unit of the first pixel node or the fixed unique ID defined by a physical feature of the first pixel node.

22. (canceled)

23. The method of supplying power and data of claim 19, wherein the wire interface is integrated with a frame having a first pixel location and a second pixel location, wherein the first pixel node is disposed at the first pixel location and the second pixel node is disposed at the second pixel location, the method further comprising:
acquiring the fixed unique ID, corresponding to the first pixel node, from the first pixel location at the first pixel node; and
acquiring the fixed unique ID, corresponding to the second pixel node, from the second pixel location at the second pixel node.

24. The method of supplying power and data of claim 23, wherein the fixed unique ID corresponding to the first pixel node is defined within a local storage unit of the pixel location.

25. The method of supplying power and data of claim 23, wherein the fixed unique ID corresponding to the first pixel node is defined by a physical feature of the pixel location.

26. The method of supplying power and data of claim 19, further comprising:
providing a first pixel node signal from the first pixel node through the wire interface at the host controller.

27. The method of supplying power and data of claim 19, further comprising:
providing the power signal and the data signal from a second host controller through the wire interface at the first pixel node and the second pixel node; and
providing a first pixel node signal from the first pixel node through the wire interface at the second host controller.

28. The method of supplying power and data of claim 19, further comprising:
providing a first pixel node signal from the first pixel node through the wire interface at the second pixel node.

29. A light-emitting display driver architecture, comprising:
a first pixel node and a second pixel node each comprising a light-emitting element; and
a frame comprising a first pixel location and a second pixel location;
wherein the first pixel location and the second pixel location each comprise a fixed unique ID;
wherein the first pixel node is disposed at the first pixel location, thereby acquiring the fixed unique ID of the first pixel location; and
wherein the second pixel node is disposed at the second pixel location, thereby acquiring the fixed unique ID of the second pixel location.
